(19) United States
(12) Patent Application Publication
(10) Pub. No.: US 2020/0032045 A1
(43) Pub. Date: Jan. 30, 2020

(54) POLYMER BLENDS FOR IMPROVED GAS BARRIER PROPERTIES

(71) Applicant: Trevira Holdings GMBH, Bobingen (DE)

(72) Inventors: Anne NEUBIG, Augsburg (DE); Uwe BAYER, Gessertshausen (DE)

(21) Appl. No.: 16/484,417

(22) PCT Filed: Feb. 8, 2018
(86) PCT No.: PCT/US2018/017319

§ 371 Date: Aug. 7, 2019

Related U.S. Application Data
(60) Provisional application No. 62/456,800, filed on Feb. 9, 2017.
(60) Provisional application No. 62/490,456, filed on Apr. 26, 2017.
(60) Provisional application No. 62/587,961, filed on Nov. 17, 2017.

(51) Int. Cl. C08L 57/00; C08L 71/02; C08L 77/10; C08L 5/16; C08L 67/02; C08L 51/00; C08K 5/098; C08K 5/00

(52) U.S. Cl. CPC C08L 57/00; C08L 71/02; C08L 77/10; C08L 5/16; C08L 67/025; C08L 2205/03; C08K 5/098; C08K 5/005; C08K 5/0041; C08L 2201/14; C08L 51/003

(57) ABSTRACT

The present invention relates to novel polymer compositions and their use in polyolefin resins. Films and rigid or semi-rigid articles made from these novel polymer compositions provide improved oxygen and/or carbon dioxide barrier protections, optical appearance and/or mechanical properties.

### CROSS REFERENCE TO RELATED PATENT APPLICATIONS

This patent application claims the benefit of priority from U.S. Provisional Application Ser. No. 62/587,961, filed Nov. 17, 2017. U.S. Provisional Application Ser. No. 62/490,456, filed Apr. 26, 2017, and U.S. Provisional Application Ser. No. 62/456,800, filed Feb. 9, 2017, each of which is incorporated herein by reference in its entirety.

### FIELD OF THE INVENTION

The present invention generally relates to a composition with improved gas barrier, optical appearance, and/or mechanical properties, and more generally relates to polymer blends with improved gas barrier, optical appearance, and/or mechanical properties, a process for making articles therefore and methods thereof.

### BACKGROUND OF THE INVENTION

Polymers such as polyesters and polyolefins have been replacing glass and metal packaging materials due to lighter weight, decreased breakage compared to glass, and potentially lower cost. One major deficiency with standard polyesters and polyolefins, however, is relatively high gas permeability. This curtails the shelf life of carbonated soft drinks and oxygen sensitive beverages or foodstuff such as beer, wine, tea, fruit juice, ketchup, cheese and the like. Organic and inorganic oxygen scavenging materials have been developed partly in response to the food industry's goal of having longer shelf-life for packaged food. These oxygen scavenging materials are incorporated into at least a portion of the package and remove oxygen from the enclosed package volume thereby inhibiting spoilage and prolonging freshness.

Articles made of polyolefinic materials, such as polyethylene (PE) and polypropylene (PP) films, plastic packaging, beverage bottles, etc., tend to display good moisture barrier and thermal processing performance, but perform poorly in preventing oxygen permeation across the wall that is in contact with the filled contents.

In bottle applications, polypropylene (PP) in particular is typically used as a copolymer with ethylene to provide impact resistance and flexibility. Adding co-monomers may lower the melting temperature and result in a higher oxygen transmission rate, both being undesirable in hot-filled, oxygen sensitive food packages.

In some applications, polyethylenes (PEs) such as HDPE moisture vapor transmission rate (MVTR) grades are high density and provide improved moisture barrier over LDPE and PP. However, PE and PP are generally co-extruded, laminated, layered and coated or surface-treated with polymers such as ethylene-vinyl alcohol (EVOH) to increase the oxygen barrier properties. This results in a more complex and expensive technology.

Other examples may include increase in the barrier properties of polypropylene as a single (mono)-layered material including passive (torturous path) technologies (such as blending in clays or “layered silicate” nanocomposites), or with addition of nanocomposites in situ.

One method of addressing gas permeability involves incorporating an oxygen scavenger into the package structure itself. In such an arrangement, oxygen scavenging materials constitute at least a portion of the package, and these materials remove oxygen from the enclosed package volume, thereby inhibiting spoilage and prolonging freshness in the case of food products.

Suitable oxygen scavenging materials include oxidizable organic polymers in which either the backbone or the side-chains of the polymer react with oxygen. Such oxygen scavenging materials are typically employed with a suitable catalyst, for example, an organic or inorganic salt of a transition metal such as cobalt. One example of an oxidizable organic polymer is a polyether. The polyether is typically used in low amounts of less than 10 weight percent of the packaging material. The polyether is oftentimes dispersed in the polymer matrix and can form discrete domains.

U.S. Pat. No. 5,641,825 relates to a composition of matter having oxygen scavenger capabilities, to a method of improving the oxygen scavenging capability of polymer-metal salt blends and to articles of manufacture formulated with such blends.

United States Patent Application No. 2014/0073741A1 relates to oxygen barrier polymers and, in particular, polyolefins with active oxygen scavenging systems.

United States Patent Application No. 2012/0252922A1 relates to a polymer composition comprising polypropylene, an adhesive polymer, and an oxygen-absorbing composition and its use for the manufacture of goods.

It may be possible to make significant oxygen barrier protection improvements by increasing the level of transition metal-based oxygen scavenging catalysts. However, increasing the transition metal levels may impact the visual appearance and properties for the food and beverage containers. For example, higher cobalt level could impart blue coloration to otherwise clear containers. The problem, therefore, is to bring improvements to the oxygen barrier performance without compromising the visual properties of the food and beverage containers.

Examples of efforts to improve oxygen barrier performance of packaging materials used for food and beverage containers may be found in European Patent Application No. 0546546 A1, disclosing a resin composition comprising a polyolefin, a thermoplastic resin, and transition metal catalyst, e.g. made into a film, sheet or container; U.S. Pat. No. 8,962,740, disclosing an oxygen scavenging composition comprising polyolefin, oxidizable polymer, and transition metal catalyst, e.g. made into a film by “compression molding”; U.S. Pat. No. 8,592,522, disclosing an oxygen absorbing resin composition comprising polyolefin, other resin “which acts as a trigger for oxidation”, and transition metal catalyst, e.g. made into a film, sheet or container; U.S. Pat. No. 7,691,290, disclosing a composition comprising a base polymer, non-polymeric oxidizable organic, and transition metal catalyst. e.g. made into a film, sheet or “preform”; and U.S. Pat. No. 7,608,341, disclosing an oxygen absorption resin composition comprising thermoplastic resin, “gas barrier resin”, and transition metal catalyst, e.g. made into a film, sheet or container. Other examples include U.S. Pat. No. 7,186,464, disclosing an oxygen barrier composition comprising an oxygen barrier polymer, oxygen scavenging polymer, and transition metal catalyst, e.g. made into a film or “rigid article”: U.S. Pat. No. 5,639,815, disclosing a package wall comprising “a base polymer which includes an oxidizable organic polymer”, and transition metal catalyst; U.S. Pat. No. 6,455,620, disclosing a composition comprising a thermoplastic polymer, an oxygen scavenging composition, and transition metal catalyst, e.g. made into a film or rigid container; and U.S. Pat. No. 7,514,152, disclosing an oxygen scavenger film including a blend of an oxygen scavenger and a polymer, and a transition metal catalyst.

Published U.S. Patent Application No. 2005/0131119 discloses grafting of a cyclodextrin compound to a polyolefin in cooperation with a lubricant to enhance lubricity of multilayered films, webs or other polymer structure.

Published U.S. Patent Application No. 2006/0105130 discloses sulfoisophthalic acid-modified polyester multilayer coextruded structures.

It would be desirable to make significant oxygen barrier protection improvements in polymers of the type used in bottle and food containers which lack sufficient gas barrier properties. In some applications, it would be desirable to make polymer articles and containers with preferential gas permeability (ethylene and carbon dioxide).

### SUMMARY OF THE INVENTION

One aspect of the present invention is directed to a composition comprising: a) polyolefin, b) polymer containing an oxidizable component, said polymer selected from the group consisting of polyethers, copolyether esters, copolyether amides, at least partially aromatic polyamides, and combinations thereof, c) a transition metal compound or mixture of transition metal compounds, and d) one or more additives, e.g. stabilizers, antioxidants, solubilizers, agents which counteract fragrances or odors, complexing agents, compatibilizing agents, colorants and/or promoters enhancing oxygen barrier properties, said composition characterized in that when an article, for example film, semi-rigid or rigid structure, is formed therefrom, the article exhibits improved gas barrier, optical appearance and/or mechanical properties as compared to a control.

Another aspect of the present invention is directed to a composition comprising: a) from 90 to 99.5 parts polyolefin, b) from 0.1 to 10 parts of polymer containing an oxidizable component, said polymer selected from the group consisting of polyethers, copolyether esters, copolyether amides, at least partially aromatic polyamides, and combinations thereof, c) from 10 to 1000 parts per million (ppm) or mg/kg, for example ≥10 ppm or mg/kg to ≤600 ppm or mg/kg, for example ≥ppm or mg/kg to ≤400 ppm or mg/kg, of transition metal or transition metal mixture, e.g. cobalt, added via a transition metal compound or mixture of transition metal compounds, e.g. cobalt carboxylate, acetate or stearate or mixtures of cobalt carboxylate, acetate or stearate and zinc stearate or acetate, and d) ≥0 to 5 parts of one or more additives, e.g. stabilizers, such as, for example, a monomeric, oligomeric or polymeric hindered amine light stabilizer (HALS), complexing agents and/or agents which counteract fragrances or odors such as, for example, beta-cyclodextrin, solubilizers and/or compatibilizing agents such as, for example, maleic anhydride grafted polyolefin, sodium and/or magnesium stearate or alkenyl succinic anhydride, colorants such as, for example, solvaperm yellow and/or promoters such as, for example, SIM ester, said composition characterized in that when an experimental article, for example film, semi-rigid or rigid structure, is formed therefrom, the article exhibits improved gas barrier, optical appearance and/or mechanical properties as compared to a control. In this embodiment, the sum of all parts is equal to 100.

Another aspect of the present invention is directed to the above composition having improved oxygen and/or carbon dioxide barrier properties wherein the polymer b) containing an oxidizable component comprises a polyamide, e.g. MXD6.

Another aspect of the present invention is directed to film having improved oxygen or carbon dioxide or both barrier properties comprising: a) polyolefin, b) polymer containing an oxidizable component, said polymer selected from the group consisting of polyethers, copolyether esters, copolyether amides, at least partially aromatic polyamides, and combinations thereof, c) a transition metal compound or a mixture of transition metal compounds, and d) one or more additives, e.g. stabilizers, antioxidants, solubilizers, agents which counteract fragrances or odors, complexing agents, compatibilizing agents, colorants and/or promoters enhancing oxygen barrier properties, said film characterized in that it exhibits improved gas barrier, optical appearance and/or mechanical properties as compared to a control film.

Another aspect of the present invention is directed to film comprising: a) from 90 to 99.5 parts polyolefin, for example 90 to 99 parts polyolefin, b) from 0.1 to 10 parts of polymer containing an oxidizable component, said polymer selected from the group consisting of polyethers, copolyether esters, copolyether amides, at least partially aromatic polyamides, and combinations thereof, c) 10 to 1000 parts per million (ppm) or mg/kg, for example ≥10 ppm or mg/kg to ≤600 ppm or mg/kg, for example ≥10 ppm or mg/kg to ≤400 ppm or mg/kg, of transition metal or transition metal mixture, e.g. cobalt, added via a transition metal compound or mixture of transition metal compounds, e.g. cobalt carboxylate, acetate or stearate or mixtures of cobalt carboxylate, acetate or stearate and zinc stearate or acetate, and d) ≥0 to 5 parts of one or more additives, e.g. stabilizers and antioxidants, such as, for example, a monomeric, oligomeric or polymeric hindered amine light stabilizer (HALS), complexing agents and/or agents which counteract fragrances or odors such as, for example, beta-cyclodextrin, solubilizers and/or compatibilizing agents such as, for example, maleic anhydride grafted polyolefin, sodium and/or magnesium stearate or alkenyl succinic anhydride, colorants such as, for example, solvaperm yellow and/or promoters such as, for example. SIM ester, said composition characterized in that when an experimental article, for example film, semi-rigid or rigid structure, is formed therefrom, the article exhibits improved gas barrier, optical appearance and/or mechanical properties as compared to a control film. In this embodiment, the sum of all parts is equal to 100.

Another aspect of the present invention is directed to the above film having improved oxygen and/or carbon dioxide barrier properties wherein the polymer b) containing an oxidizable component comprises a polyamide, e.g. MXD6.

Another aspect of the present invention is directed to a rigid or semi-rigid article comprising: a) polyolefin, b) polymer containing an oxidizable component, said polymer selected from the group consisting of polyethers, copolyether esters, copolyether amides, at least partially aromatic polyamides, and combinations thereof, c) a transition metal compound or a mixture of transition metal compounds, and d) one or more additives, e.g. stabilizers, antioxidants, solubilizers, agents which counteract fragrances or odors, complexing agents, compatibilizing agents, colorants and/or promoters enhancing oxygen barrier properties, said film characterized in that it exhibits improved gas barrier, optical appearance and/or mechanical properties as compared to a control article.

Another aspect of the present invention is directed to a rigid or semi-rigid article comprising: a) from 90 to 99.5 parts polyolefin, b) from 0.1 to 10 parts of polymer containing an oxidizable component, said polymer selected from the group consisting of polyethers, copolyether esters, copolyether amides, at least partially aromatic polyamides, and combinations thereof, c) 10 to 1000 parts per million (ppm) or mg/kg, for example ≥10 ppm or mg/kg to ≤600 ppm or mg/kg, for example ≥10 ppm or mg/kg to ≤400 ppm or mg/kg, of transition metal or transition metal mixture, e.g. cobalt, added via a transition metal compound or mixture of transition metal compounds, e.g. cobalt carboxylate, acetate or stearate or mixtures of cobalt carboxylate, acetate or stearate and zinc stearate or acetate, and d) ≥0 to 5 parts of one or more additives, e.g. stabilizers, such as, for example, a monomeric, oligomeric or polymeric hindered amine light stabilizer (HALS), complexing agents and/or agents which counteract fragrances or odors such as, for example, beta-cyclodextrin, solubilizers, antioxidants, and/or compatibilizing agents such as, for example, maleic anhydride grafted polyolefin, sodium and/or magnesium stearate or alkenyl succinic anhydride, colorants such as, for example, solvaperm yellow and/or promoters such as, for example, SIM ester, said composition characterized in that when an experimental article, for example film, semi-rigid or rigid structure, is formed therefrom, the article exhibits improved gas barrier, optical appearance and/or mechanical properties as compared to a control article. In this embodiment, the sum of all parts is equal to 100.

Another aspect of the present invention is directed to the above rigid or semi-rigid article having improved oxygen or carbon dioxide or both barrier properties wherein the polymer b) containing an oxidizable component comprises a polyamide, e.g. MXD6.

### DETAILED DESCRIPTION OF THE INVENTION

The term “barrier”, as used herein, means a material formation or structure that prevents or obstructs movement, passage or access across the two sides that the barrier separates or divides. Non-limiting examples of barrier are rigid or flexible container walls, rigid or flexible films, rigid or flexible membranes and separators.

By the phrase “improved gas barrier properties” as used herein, it is meant any detectable decrease in transmission of oxygen and/or carbon dioxide and/or preferential gas permeability of ethylene and carbon dioxide in composition or film of the present invention as compared to control compositions/films. In one nonlimiting embodiment, improved gas barrier properties are determined via measurement of a decrease in total oxygen over a selected time frame into a closed, rigid or flexible container or article of the present invention as compared to total oxygen in a control over the same time frame.

By the phrase “improved optical appearance properties”, as used herein, it is meant to include, but is not limited to, any decrease in blue tinge and/or haze and/or any increase in clarity in a film or article produced from a composition of the present invention as compared to a control film or article which is measurable or observed visually by a skilled artisan.

By the phrase “improved mechanical properties” as used herein, it is meant to include, but is not limited to, any measurable increase in strength, toughness, heat stability and/or ease in recyclability in a film or article produced from a composition of the present invention as compared to a control film or article.

By “control” or “control composition” or “control film” or “control article” it is meant a composition, film or article which does not contain all elements of the compositions, films or articles of the present invention and/or contains elements in the compositions, films or articles at ranges less than or greater than those disclosed herein.

The term “polyolefin(s)”, as used herein, encompasses a class of thermoplastic polymers that are widely used in the consumer and petrochemicals industry. Polyolefins are typically produced from a simple olefin (also called an alkene with the general formula CnH2n) as a monomer. For example, polyethylene (PE) is the polyolefin produced by polymerizing the olefin ethylene (C2H4). Polypropylene (PP) is another common polyolefin which is made from the olefin propylene (C3H6). Copolymers of ethylene and propylene are also useful thermoplastic polymers in accordance with the present disclosure.

Other non-limiting examples of polyolefins, as used in the present disclosure, are described in U.S. Pat. No. 8,981,013 B2. These may include, but are not limited to, ethylene-based polymers such as high density polyethylene (HDPE), low density polyethylene (LDPE), linear low density polyethylene (LLDPE), homogeneously branched linear ethylene/a-olefin interpolymers or homogeneously branched substantially linear ethylene/a-olefin interpolymers; propylene-based polymers such as propylene homopolymers and propylene interpolymers that can be random or block copolymers, branched polypropylene, or a propylene-based terpolymer; a blend of two of more polyolefins, such as a blend of an ethylene-base polymer and a propylene-base polymer discussed above; halogenated ethylene-based polymers such as chlorinated ethylene-based polymers and fluorinated ethylene-based polymers.

In some embodiments of the present invention, polyolefins may also include elastomeric polymers such as homopolymers of conjugated dienes, especially butadiene or isoprene, and random, or block, copolymers and terpolymers of at least one conjugated diene, especially butadiene or isoprene, with at least one aromatic a-olefin, especially styrene and 4-methylstyrene, aromatic diolefin, especially divinylbenzene.

In other embodiments of the present invention, polyolefins may include natural or synthetic polyisoprene (PI) and polybutadiene (PB).

Polypropylene (PP) used may also be a bottle-grade resin such as PolyOne® 23N1OA, a Flint Hills Resources polypropylene random copolymer. Other suitable polypropylene base polymers may include VERSIFY® polymers (The Dow Chemical Company) and VISTAMAXX® polymers (ExxonMobil Chemical Co.), LICOCENE′″ polymers (Clariant), EASTOFLEX® polymers (Eastman Chemical Co.), REXTAC® polymers (Hunstman), Basell-Polyolefin (Basell) and VESTOPLAST′″ polymers (Degussa). Other suitable polymers may include propylene-a-olefins block copolymers and interpolymers, polypropylene made from metallocene or post metallocene catalysts and catalytic processes, such as, but not limited to, suitable grades commercially available from TOTAL Petrochemicals, LyondellBasell and ExxonMobil, and other propylene based random, block, heterophasic, or otherwise suitable copolymer and interpolymers known in the art.

In some other embodiments, the improved barrier properties of the present invention may be applicable to biopolymers, biopolymer alloys and biopolymer composites.

The composition providing improved gas barrier properties may comprise a polymer containing an oxidizable component selected from the group consisting of polyethers, copolyether-esters, copolyether amides, at least partially aromatic polyamides, and combinations thereof. In one nonlimiting embodiment, the polymer containing an oxidizable component is a polyether, namely polyether glycol.

In some embodiments, the barrier may comprise no more than 10% by weight of the polymer containing an oxidizable component. In other embodiments, the barrier may comprise no more than 9%, no more than 8%, no more than 7%, no more than 6%, no more than 5%, no more than 4%, no more than 3%, no more than 2%, no more than 1%, or no more than 0.5/% of the polymer containing an oxidizable component. All percentages are on the weight basis, relative to the total composition.

In some embodiments, the barrier may comprise ≥10% by weight and ≤50% by weight of the polymer containing an oxidizable component.

When the polymer containing an oxidizable component comprises an at least partially aromatic polyamide, the barrier may comprise ≥1 and ≤30 wt % of the polymer, for example, ≥2 and ≤15 wt % of the polymer.

When the polymer containing an oxidizable component comprises a polyether glycol, the barrier may comprise ≥0.5 and ≤10 wt % of the polymer, for example, ≥0.5 and ≤4 wt % of the polymer.

In some embodiments of the present invention, the polymer (b) containing an oxidizable component may comprise one or more polyether segments having a number-average molecular weight of from about 200 to about 5000 g/mol. In some embodiments, the polyether in the polymer composition may have a number-average molecular weight of from about 600 to about 3500 g/mol, and more specifically about 800 to about 3000 g/mol, that the polymer composition contains one or more polyether segments in an amount of about 5 to about 60 wt %, in particular about 10 to about 50 wt %.

In some embodiments of the present invention, the polymer (b) containing an oxidizable component is a copolyether ester containing polyether segments in an amount of about 15 to about 45 wt %, relative to the total polymer (b) composition.

In some nonlimiting embodiments of the present invention, the polymer (b) containing an oxidizable component is a copolymer of polyolefin and polyether, containing polyether segments in an amount of about 10 to about 95 wt %, relative to the total polymer (b) composition. In this embodiment, the copolymer may be obtainable by a melt compounding steps of the polyolefin and polyether segments.

In some nonlimiting embodiments of the present invention, the polymer (b) containing an oxidizable component is a modified polyether, containing polyether segments in an amount of about 60 to about 99 wt %, relative to the total polymer (b) composition.

Advantageously, the polyether segment is a poly (C2-C6-alkylene) glycol segment. The C2-C6-alkylene glycol may be a linear or branched aliphatic C2-C6-moiety. In some embodiments, the polyether segment is a linear or branched poly (C2-C6-alkylene) glycol segment.

Specific examples of such polymer compositions include poly (ethylene glycol), linear or branched poly (propylene glycol), linear or branched poly (butylene glycol), linear or branched poly (pentylene glycol), linear or branched poly (hexylene glycol), poly (tetramethylene ether) glycol, as well as mixed poly (C2-C6-alkylene) glycols obtained from two or more of the glycolic monomers used in preparing the above-mentioned examples. Advantageously, the polyether segment is a linear or branched poly (propylene glycol) or a linear or branched poly (butylene glycol). Compounds having three hydroxyl groups (glycerols and linear or branched aliphatic trials) could also be used.

The terms “transition metal” or transition metal mixture”, as used herein, means any of the set of metallic elements occupying Groups IVB-VIII, IB, and liB, or 4-12 in the periodic table of elements. Non-limiting examples are cobalt, manganese, copper, chromium, zinc, iron, nickel, and combinations or mixtures thereof. The transition metals have variable chemical valence and a strong tendency to form coordination compounds.

The term “transition metal compound”, as used herein, means those transition metal compounds, also referred to as catalyst, that activate or promote the oxidation of the oxidizable component of the polymer by ambient oxygen. Examples of suitable transition metal compounds include compounds comprising cobalt, manganese, copper, chromium, zinc, iron, or nickel and mixtures thereof. It is also possible that the transition metal compound is incorporated in the polymer matrix during extrusion for example. The transition metal compound can be added during polymerization or compounded into suitable polymer thereby forming a masterbatch that can be added during the preparation of the article. In one nonlimiting embodiment, the transition metal compound is added as a liquid or together with a liquid carrier. In one nonlimiting embodiment, the transition metal compound is included in a liquid or solid masterbatch. In one non-limiting embodiment, the transition metal compound is added as a melt. In one nonlimiting embodiment, the transition metal compound In one nonlimiting embodiment, a transition metal compound, such as a cobalt compound for example, may be physically separate from the polymer composition, for example a sheath core or side-by-side relationship, so as not to activate the polymer composition prior to melt blending into a film, article or preform.

In some embodiments, the transition metal compound may include, but is not limited to, a transition metal salt of i) a metal comprising at least one member selected from the group consisting of cobalt, manganese, copper, chromium, zinc, iron, and nickel, and ii) an inorganic or organic counter ion comprising at least one member selected from the group of carboxylate, such as neodecanoates, octanoates, stearates, acetates, naphthalates, lactates, maleates, acetylacetonates, linoleates, oleates, palminates or 2-ethyl hexanoates, oxides, carbonates, chlorides, dioxides, hydroxides, nitrates, phosphates, sulfates, silicates, or mixtures thereof. Such cobalt metal-containing compositions or mixtures of, for example cobalt-containing compositions and zinc-containing compositions may be added separately or pre-mixed into the polymer (b).

In some embodiments, the transition metal catalyst carriers may include microcrystalline cellulose (MC) as a potential carrier for the transition metal.

In some embodiments, the oxidizable component in the polymer compositions comprising transition metals may be bio-resourced a-tocopherol, poly (alpha-pinene), poly (beta-pinene), poly (dipentene), and poly (d-limonene).

In embodiments of the present invention, the transition metal catalyst may be a cobalt salt, in particular a cobalt carboxylate, and especially a cobalt Cs-C2o carboxylate. The Cs-C2o carboxylate may be branched or unbranched, saturated or unsaturated. The cobalt

compound may be physically separate from the polymer composition, for example a sheath core or side-by-side relationship, so as not to activate the polymer composition prior to melt blending into a container.

Compositions of the present invention further comprise one or more additives, e.g. stabilizers, antioxidants, solubilizers, agents which counteract fragrances or odors, complexing agents, compatibilizing agents, colorants and/or promoters enhancing oxygen barrier properties. In one nonlimiting embodiment, an additive or additives is added separately. In another non-limiting embodiment, the additive or additives is included in one or more masterbatches.

Nonlimiting examples of stabilizers which can be used include monomeric, oligomeric or polymeric hindered amine light stabilizers (HALS). In some embodiments, the HALS may be a polymeric HALS, such as Uvinul®® 5050, Uvinul® 4050, oligomeric or polymeric HALS, such as Uvinul® 5062. In some other embodiments, the HALS may be a mixture of compounds, such as Uvinul® 4092. Other suitable HALS include but are not limited to Uvinul® 4077, Uvinul®4092, Nylostab®, Tinuvin®, Hostavin® and Nylostab® S-EED®.

Nonlimiting examples of solubilizers or complexing agents include cyclodextrins such as beta-cyclodextrin.

Inclusion of beta-cyclodextrin is also believed to reduce or mask odors as this agent may act to counteract fragrances or odors.

Nonlimiting examples of compatibilizing agents include sodium stearate, magnesium stearate, mixtures thereof and alkenyl succinic anhydride. Additional nonlimiting examples of compatibilizing agents include blends of poly-a-olefin and polyester that can be made using reactive compounding techniques using maleated polypropylene or poly[methylene (phenylene isocyanate)] or (PMPI), anhydrides of unsaturated dicarboxylic acids, such as maleic, citraconic and itaconic acids, acrylic-modified olefinic ionomers containing sodium, zinc, cobalt, and a variety of metals and those further described in International Review of Chemical Engineering 2011, Vol. 3, p 153-215. Methods for producing compatibilizing agents for use herein, such as extrusion of hot melt resins, the solvothermal method, mixed monomer systems synthesis, free radical grafting by irradiation or other, are known in the art.

Oligomeric polyethers modified with sulfonic acid groups such as disclosed in U.S. Pat. No. 9,447,321, which is incorporated herein by reference, also provide useful compatibilizers or interfacial agents for improving compatibility/dispersability of the oxidizable component in the polymer (polyolefin) matrix. Higher molecular weight polyethers can also be used. The compatibilizers or interfacial agents can be added directly or for example pre-reacted with the polyether compound to form a modified polyether. The oligomeric polyether compounds or higher molecular weight polyethers can be modified e.g. end-capped or reacted at each end or just one end. Possible reactants can be anhydrides or carboxylic acids. Examples, include, but are not limited to, maleic acid anhydride grafted polypropylenes, alkenyl succinic anhydrides and adipic acid. The modified oligomeric polyether compounds can be obtained directly in a pre-reaction step or e.g. when producing a masterbatch in an extrusion step.

The term “colorant”, as used herein, can be an organic or inorganic chemical compound that is capable of imparting coloration to a substance, including masking, balancing or countering the absorbance of a substance in the 300-600 nm wavelength. It may be possible to use colorants such as inorganic pigments, for example, iron oxide, titanium oxide and Prussian blue, and organic colorants such as alizarin colorants, azo colorants and metal phthalocyanine colorants, and trace nutrients such as salts of iron, manganese, boron, copper, cobalt, molybdenum and zinc. It may be advantageous for the colorants to have good thermal and chemical stability.

In some embodiments, the colorant may comprise of industrial, commercial and developmental class of pigments, dyes, inks, paint, and combinations thereof. In other embodiments, the colorant may comprise of synthetic, natural, bio-derived compounds and combinations thereof. In some other embodiments, the colorant may comprise of chemical compounds from a class of hetero-aromatic compounds. It will be understood that the skilled person may run trial-and-error experiments to determine the optimum levels of such colorants in specific applications.

A nonlimiting example of a dye, colorant or pigment added to reduce any blue color resulting from the cobalt and/or sodium stearate is Solvaperm yellow.

Nonlimiting examples of promoters enhancing oxygen barrier properties, also referred to as ionic compatibilizers as described in EP 1663630, teachings of which are incorporated herein by reference, include copolyesters containing a metal sulfonate salt group. The metal ion of the sulfonate salt may be Na+, Li+, K+, Zn++, Mn++, Ca++ and the like. The sulfonate salt group is attached to an aromatic acid nucleus such as a benzene, naphthalene, diphenyl, oxydiphenyl, sulfonyldiphenyl, or methylenediphenyl nucleus. In one nonlimiting embodiment, the aromatic acid nucleus is sulfophthalic acid, sulfoterephthalic acid, sulfoisophthalic acid, 4-sulfonaphthalene-2,7-dicarboxylic acid, or an ester thereof. In one nonlimiting embodiment, the sulfomonomer is 5-sodiumsulfoisophthalic acid or 5-zincsulfoisophthalic acid and a dialkyl ester thereof such as the dimethyl ester (SIM) or glycol ester (SIPEG). In one nonlimiting embodiment, the promoter is 5-sulfoisophthalic acid dimethyl ester sodium salt (SIM ester) or a counterion such as Li, Na, K and Zn, the free acid with no ester, or a different ester, such as, but not limited to, methyl, ethyl and ethylene glycol.

Embodiments of some aspects of the invention may further comprise additional additives, such as, for example, antioxidants; ionic compatibilizers; fillers; branching agents; reheat agents; anti-blocking agents; anti-static agents; biocides; blowing agents: coupling agents; anti-foaming agents: flame retardants; heat stabilizers: impact modifiers: crystallization aids; clarifiers; lubricants; plasticizers; processing aids; buffers; colorants: slip agents; and combinations thereof. It will be understood that the skilled person may run trial-and-error or design experiments to determine the optimum levels of such additives for specific applications.

In one nonlimiting embodiment, an additive or additives is added separately to the composition. In one nonlimiting embodiment, an additive or additives are incorporated by liquid dosing. In another nonlimiting embodiment, the additive or additives is included in one or more masterbatches used to prepare the compositions. As will be understood by the skilled artisan upon reading this disclosure, the one or more masterbatches with or without additives used in the composition may be homogeneous or blended. Further, the one or more additives included in the compositions may be incorporated via the same method, e.g. both in a single masterbatch, both by separate addition, or both in a liquid dosing mixture, or via different methods, e.g. one or more additives in a single masterbatch and one or more separate additives, or one or more additive in one masterbatch and one or more additive in a second masterbatch, into the compositions of the present invention.

Suitable examples of antioxidants include, but are not limited to, phenolic antioxidants, aminic antioxidants, sulfur-based antioxidants and phosphites, and mixtures thereof. Non-limiting examples of antioxidants are described in Plastics Additives, Pritchard, G., Ed. Springer Netherlands: 1998; Vol. 1, pp 95-107. Non-limiting examples of such antioxidants include butylated hydroxytoluene (BHT), Ethanox® 330, Ethanox® 330G, IRGANOX 1330, Hostanox® PEP-Q, tert-butyl phenols and mixtures thereof.

In some embodiments, the antioxidant may be selected from the group consisting of hindered phenols, sulfur-based antioxidants, hindered amine light stabilizers and phosphites. In a further embodiment, the antioxidant may be selected from the group consisting of hindered phenols, sulfur-based antioxidants and phosphites. Examples of such antioxidants include, but are not limited to 1,3,5-trimethyl-2,4,6-tris(3,5-di-tert-butyl-4-hydroxybenzyl)-benzene (CAS: 1709-70-2), tetrakis(2,4-di-tert-butylphenyl)-1,1-biphenyl-4,4′-diylbisphosphonite (CAS: 38613-77-3) or pentaerythritol tetrakis 3-(3,5-di-tert-butyl-4-hydroxyphenyl)propionate (CAS: 6683-19-8), (5R)-[(1S)-1,2-Dihydroxyethyl]-3,4-dihydroxyfuran-2(5H)-one (Ascorbic acid CAS: 50-81-7); a-tocopherol (vitamin E form antioxidant agent. CAS: 59-02-9).

In some embodiments, an ionic compatibilizer may be a separately added additive.

The melting point of the composition providing gas barrier properties of the present invention can be conveniently controlled by adjusting various characteristics or parameters of the composition, as known to those skilled in the art. For instance, one skilled in the art may opt to suitably select the molecular weight of the polyether segment, and/or the weight ratio of polyolefin segment to polyether segment to adjust the melting point. It is also possible to select different types of polyolefin to adjust the melting point. Thus, one skilled in the art may select or mix suitable polyolefins to reliably adjust the melting point of the polymer composition. Other options include suitably selecting the type of polyether. For instance, the chain length and the presence or absence of a side chain influences the melting point of the polymer composition. A further possibility is to modify the polyether as described herein. A further possibility is the addition of additives. Another possibility is the molecular weight distribution obtained by combining or otherwise mixing varying polyolefins to provide a melting range that may be in favor of thermal transitions suited to the article being formed. One embodiment of the composition providing gas barrier properties is liquid at 25° C.

Similarly, the optical appearance of the resulting film or article can be conveniently controlled by adjusting various characteristics or parameters of the composition of the present invention, as known to those skilled in the art. For instance, one skilled in the art may opt to suitably select the molecular weight of the polyether segment, and/or the weight ratio of polyolefin segment to polyether segment to adjust the optical appearance. It is also possible to select different types of polyolefin to adjust the optical appearance. Thus, one skilled in the art may select or mix suitable polyolefins to reliably adjust the optical appearance of the polymer composition. A further possibility is to use a modified polyether as described herein. Other options include suitably selecting the type of polyether. For instance, the chain length and the presence or absence of a side chain influences the optical appearance of a film or article produced from the polymer composition. A further possibility is the addition of additives.

In one nonlimiting embodiment, the composition for imparting improved oxygen barrier, optical appearance and/or mechanical properties comprises: a) from 90 to 99.5 parts polyolefin, b) from 0.1 to 10 parts of polymer containing an oxidizable component, said polymer selected from the group consisting of polyethers, copolyether esters, copolyether amides, at least partially aromatic polyamides, and combinations thereof, c) from 10 to 1000 parts per million (ppm) or mg/kg, for example ≥10 ppm or mg/kg to ≤600 ppm or mg/kg, for example ≥10 ppm or mg/kg to ≤400 ppm or mg/kg, of transition metal, e.g. cobalt, added via a transition metal compound or mixture of transition metal compounds, e.g. cobalt carboxylate or stearate or mixtures of cobalt carboxylate or stearate and zinc stearate or acetate, and d) ≥0 to 5 parts of one or more additives, e.g. stabilizers, such as, for example, a monomeric, oligomeric or polymeric hindered amine light stabilizer (HALS), complexing agents and/or agents which counteract fragrances or odors such as, for example, beta-cyclodextrin, solubilizers and/or compatibilizing agents such as, for example, sodium and/or magnesium stearate or alkenyl succinic anhydride, colorants such as, for example, solvaperm yellow and/or promoters such as, for example, SIM ester. In this embodiment, the sum of all parts is equal to 100.

In one nonlimiting embodiment, the composition is characterized in that when an experimental article, for example film, semi-rigid or rigid structure, is formed therefrom and oriented in the x and/or y direction from 50 to 400% or in a machine direction (MD) of 1:5 to 1:10 equal to 500% to 1000% or a transverse direction (TD) of 1:5 to 1:10 equal to 500% to 1000% (see Nentwig KunsstoffFolien, Hanser 2000, page 109), the article exhibits lower oxygen and/or carbon dioxide transmission than a comparative article formed from a control composition when oriented in the x and/or y direction from 50 to 400%, or in a machine direction (MD) of 1:5 to 1:10 equal to 500% to 1000% or a transverse direction (TD) of 1:5 to 1:10 equal to 500% to 1000% or from a composition with the same components as the instant invention when not oriented in the x and/or y direction from 50 to 400% or in a machine direction (MD) of 1:5 to 1:10 equal to 500% to 1000% or a transverse direction (TD) of 1:5 to 1:10 equal to 500% to 1000%, wherein the experimental article and the comparative article have the same finished wall thickness. In some embodiments of the present invention, the article has been oriented at least 50% in the x direction and/or at least 50% in the y direction. In other embodiments of the present invention, the article has been oriented at least 100% in at least one direction.

In some embodiments of the present invention, the article is a gas barrier wherein the gas is oxygen, carbon oxides or both.

In some embodiments, the article is in the form of a film. In other embodiments, the article is a multilayer film. In other embodiments, the article is rigid or semi-rigid structure.

The term “article”, as used herein, means a particular form or physical object that comprises the barrier composition of the present invention. Non-limiting examples of articles are stretch-molded, blow-molded, extruded physical objects of defined shapes, sizes and forms. These may include, but are not limited to, bottles, containers, hollow blocks or shapes, planar or non-planar trays, film, sheet, tubing, pipe, fiber, container preforms, blow molded articles such as rigid containers, thermoformed articles, flexible bags and the like and combinations thereof.

In some embodiments of the present invention, rigid or semi-rigid articles can be formed from plastic, paper or cardboard cartons or bottles such as juice, milk, soft drink, beer and soup containers, thermoformed trays or cups.

The following Examples demonstrate the present invention and its capability for use. The invention is capable of other and different embodiments, and its several details are capable of modifications and/or substitution in various apparent respects, without departing from the spirit and scope of the present invention. Accordingly, the Examples are to be regarded as illustrative in nature and non-limiting.

### Materials Used in the Examples:

Commercial grade, INVISTA Terathane® PTMEG 1400 and Terathene® PTMEG 2900) Poly (tetramethylene ether) Glycol or PTMEG 14001 PTMEG 2900 (CAS No. 25190-06-1) are used in examples of the present disclosure. Terathane® PTMEG 1400 has a number average molecular weight of 1400 g/mole, stabilized with 200-350 ppm BHT (CAS No. 128-37-0). Terathane® 2900 has a number average molecular weight of 2900 g/mole, stabilized with 300-500 ppm BHT. Amounts of the tetramethylene ether glycol useful in the polyether additive preparations of Example 4 and Example 5 range from about 80 to about 220 kg.

A commercially available antioxidant, Ethanox®) 330 (CAS No. 1709-70-2), is used in examples of the present disclosure, such as that manufactured by SI Group. Typical commercial purity of Ethanox® 330 is greater than 99% by weight. Amounts of the Ethanox® 330 useful in the masterbatch preparations of Example 1 and Example 5 range from 0 to about 6.0 kg. Amounts of the Ethanox® 330 useful in the polyether additive preparations of Example 4 range from about 0.01 to about 11.0 kg.

An industrial hindered amine light stabilizer HALS, Uvinul® 4050 FF (CAS No. 124172-53-8), as used in examples of the present disclosure, is manufactured by BASF. Uvinul®® 4050 FF, i.e., N,N′-bisformyl-N,N′-bis-(2,2,6,6-tetramethyl-4-piperidinyl)-hexamethylendiamine, is a sterically hindered monomeric amine with the molecular mass of 450 g/mol. Amounts of the HALS useful in the polyether additive preparations of Example 4 and Example 5 range from about 0.5 to about 6.0 kg.

An industrial sterically hindered amine light stabilizer Chimassorb® 944 FDL (CAS No. 70624-18-9), as used in examples of the present disclosure, is manufactured by BASF. Amounts of Chimassorb® 944 FDL useful in the polyether additive preparations of Example 4 range from about 10 to about 22 kg.

A commercially available antioxidant Cyanox® 1790 (CAS No. 40601-76-1), is used in examples of the present disclosure, such as that manufactured by Solvay. Amounts of the Cyanox® 1790, i.e., Tris(4-t-butyl-3-hydroxy-2,6-dimethylbenzyl)-s-triazine-2,4,6-(1H,3H,5H)trione, useful in the masterbatch preparations of Example 4 range from 4.0 to about 11.0 kg.

An industrial phosphorus based antioxidant Hostanox® P-EPQ P (CAS No. 119345-01-6), as used in examples of the present disclosure, is manufactured by Clariant. Amounts of Hostanox® P-EPQ P useful in the masterbatch preparations of Example 4 range from about 4.5 to about 5.5 kg.

Cobalt stearate (CAS No. 13586-84-0), as used in Examples 1a-1m and Example 5 of the present disclosure, is manufactured and supplied by Umicore under the “Ecos S 9.5: cobalt stearate 9.5%” product name. Amounts of the cobalt stearate useful in the masterbatch preparations of Example 1 and 5 range from about 20 to about 200 kg.

Zinc stearate (CAS No. 557-05-1), used in examples of the present disclosure, is supplied by Sigma-Aldrich® as zinc stearate purum. The zinc content is 10-12% by weight. Amounts of the zinc stearate useful in the polyether additive preparations of Example 4 range from about 0.05 to about 0.13 kg.

Sodium stearate (CAS No. 68424-38-4), as used in examples of the present disclosure, is supplied by Peter Greven GmbH & Co. KG. Germany, under the “Ligastar NA R/D” product trade name. The sodium content in Ligastar NA RID is about 6% by weight. Amounts of the sodium stearate useful in the masterbatch preparations of Example 1 range from about 6 to about 19 kg.

Magnesium stearate (CAS No. 557-04-0), as used in examples of the present disclosure, is supplied by Peter Greven GmbH & Co. KG. Germany, under the “Ligastar MG 700” product trade name. The magnesium content in Ligastar MG 700 is about 4.4% by weight. Amounts of the magnesium stearate useful in the masterbatch preparations of Example 1 range from about 9 to about 24 kg.

Beta-Cyclodextrin (CAS No. 7585-39-9), as used in examples of the present disclosure, is commercially available from Wacker Chemie AG under the “CAVAMAX® W7 FOOD” product trade name. Beta-Cyclodextrin has seven glucose units and a molecular weight of 1135 g/mol. Amounts of the beta-cyclodextrin useful in the polyether additive preparations of Example 4 range from 0 to about 40 kg.

Aromatic polyamide (poly (m-xylene adipamide)) MXD6 used in examples is commercially available from Mitsubishi Gas Chemical Company, MXD6 S6007 (CAS: 25718-70-1). Amounts of the aromatic polyamide useful in the MXD6 additive preparation in Example 2 range from about 360 to about 440 kg.

5-Sulfoisophthalic acid dimethyl ester sodium salt (SIM ester; CAS No. 3965-55-7), is commercially available from Sigma-Aldrich® under the “Dimethyl5-sulfoisophthalate sodium salt” name with a molecular weight of 296.3 g/mol. Amounts of SIM ester used in the masterbatch preparations of Example 1 and polyether additive preparations of Example 4 range from 0 to about 40 kg.

Polypropylene used in examples is commercially available as Total mPP Lumicene® CAS No. 9003-07-0: 9010-79-1. Amounts of the polypropylene useful in the masterbatch preparations of Example 1 range from about 0 to about 950 kg. Amounts of the polypropylene useful in the MXD6 additive preparation in Example 2 range from about 180 to about 220 kg. Amounts of the polypropylene useful in the polyether additive preparations of Example 4 and Example 5 range from about 250 to about 995 kg.

Maleic anhydride grafted PP (PP-g-MA) is commercially available from Arkema under the OREVAC® CA 100 product name or from Addcomp Holland BV under the PRIEX® 25097 product name. Amounts of the PP-g-MA useful in the masterbatch preparation of Example 1 range from 0 to about 960 kg. Amounts of the PP-g-MA useful in the MXD6 additive preparation in Example 2 range from about 360 to about 440 kg, Amounts of the PP-g-MA useful in the polyether additive preparation of Example 4 and Example 5 range from 0 to about 920 kg

Solvaperm Yellow 2G (CAS No. 7576-65-0) with the color index of Solvent Yellow 114, as used in examples of the present disclosure, is a registered product trademark of Clariant Chemicals. Amounts of the colorant useful in the polyether additive preparations of Example 4 and Example 5 range from 0 to about 0.05 kg.

Octenyl succinic anhydride (n-OSA) (CAS No. 26680-54-6) is commercially available from Trigon Chemie GmbH. Amounts of the n-OSA useful in the masterbatch preparation of Example 4 range from 0 to about 5 kg.

### EXAMPLES

### Examples 1 (a-m)—Polypropylene Cobalt Stearate Masterbatch (Catalyst-ME) Preparation

PP-g-MA is used as received pure or in a premix with PP to provide the matrix material/source material for the extrusion step.

Cobalt stearate, sodium stearate, magnesium stearate, 5-Sulfoisophthalic acid dimethyl ester sodium salt (SIM ester), and Ethanox® 330 are added directly in the melt extrusion step, respectively. The melt extruder used is a co-rotating, 27 mm extruder screw diameter and screw length to diameter (L:D) ratio of 36:1, for example, Leistritz Micro 27 36D model melt extruder. The polymer processing rate is about 5 kg/hr. Stage-wise operating temperatures are: water at room temperature (TO), 200° c. (T1-T4), 205° c. (T5-T7), 210° c. (T8) and 220° c. (T9). The desired molten material is extruded into a deionized water cooling bath. The cooled polymer strands are pelletized with a Pell-tec pelletizer into typical cylindrical granules of about 2 mm diameter and about 3 mm length.

Either of the stearates, SIM ester, and/or PP-g-MA in the final Cobalt stearate Masterbatch (Catalyst-ME) composition may be varied by adjusting the amounts of stearate and/or PP-g-MA, respectively.

In one embodiment, 1000 kg of Catalyst-MB product is prepared using the following component quantities as listed in Tables 1 and 2.

TABLE 1

| | 1a | 1b | 1c | 1d | 1e | 1f | 1g | 1h | 1i | 1j | 1k | 1l | 1m |
|---|---|---|---|---|---|---|---|---|---|---|---|---|---|
| | Amt, | Amt, | Amt, | Amt, | Amt, | Amt, | Amt, | Amt, | Amt, | Amt, | Amt, | Amt, | Amt, |
| Component | kg | kg | kg | kg | kg | kg | kg | kg | kg | kg | kg | kg | kg |
| Polypropylene | 920 | 736 | 722.6 | 722.6 | 919.8 | 903.1 | 897.1 | 900.1 | 889.8 | 724 | 724 | 920 | 0 |
| Lumicene ® | | | | | | | | | | | | | |
| PP-g-MA | 0 | 184 | 180.7 | 180.6 | 0 | 0 | 0 | 0 | 0 | 196 | 0 | 0 | 920 |
| Orevac ® | | | | | | | | | | | | | |
| CA 100 | | | | | | | | | | | | | |
| PP-g-MA | 0 | 0 | 0 | 0 | 0 | 0 | 0 | 0 | 0 | 0 | 196 | 0 | 0 |
| PRIEX ® | | | | | | | | | | | | | |
| 25097 | | | | | | | | | | | | | |
| Cobalt | 80 | 80 | 80 | 80 | 80 | 80 | 80 | 80 | 80 | 80 | 80 | 80 | 80 |
| Stearate | | | | | | | | | | | | | |
| Ethanox ® | 0 | 0 | 0 | 0.1 | 0.2 | 0.2 | 0.2 | 0.2 | 0.2 | 0.2 | 0.2 | 0.2 | 0 |
| 330 | | | | | | | | | | | | | |
| Sodium | 0 | 0 | 16.7 | 16.7 | 0 | 16.7 | 0 | 8.35 | 0 | 0 | 0 | 0 | 0 |
| Stearate | | | | | | | | | | | | | |
| Magnesium | 0 | 0 | 0 | 0 | 0 | 0 | 22.7 | 11.35 | 0 | 0 | 0 | 0 | 0 |
| Stearate | | | | | | | | | | | | | |
| SIM ester | 0 | 0 | 0 | 0 | 0 | 0 | 0 | 0 | 30 | 0 | 0 | 0 | 0 |

### Example 2—MXD6 Additive Preparation

PP-g-MA is used as received in a premix with PP and MXD6 to provide the source material for the extrusion step.

The melt extruder used is a co-rotating, 27 mm extruder screw diameter and screw length to diameter (L:D) ratio of 36:1, for example, Leistritz Micro 27 36D model melt extruder. The polymer processing rate is about 5 kg/hr. Stage-wise operating temperatures are: water at room temperature (TO), 240° c. (T1), 250° c. (T2-T8), and 255° c. (T9). The desired molten material is extruded into a deionized water cooling bath. The cooled polymer strands are pelletized with a Pell-tec pelletizer into typical cylindrical granules of about 2 mm diameter and about 3 mm length.

Either of the polyamide and/or PP-g-MA in the final MXD6 additive composition may be varied by adjusting the amounts of polyamide and/or PP-g-MA, respectively.

In one embodiment, 1000 kg of MXD6 additive product is prepared using the following component quantities as listed in Table 2.

TABLE 2

| | 8 |
|---|---|
| Component | Amount, kg |
| Polypropylene | 200 |
| MXD6 S6007 | 400 |
| PP-g-MA Orevac ® CA | 400 |

### Example 3—Incorporation of Catalyst Masterbatch and MXD6 (Additive) into Polyolefins

Catalyst Masterbatch and MXD6 (pure or as additive shown in Table 2) may be mixed prior to use for injection molding with any polyolefin base resin.

In this example, Catalyst Masterbatch as shown in Examples 1a-m is used in concentrations of 1-15 wt % for injection molding into preforms and further stretch blow molding into bottles. MXD6 may be used pure or as an additive (cf. example 2) in a premix with the base resin or premixed with catalyst masterbatch to obtain 2-12 wt % MXD6 in the final application. The MXD6 amount may be varied further by adjusting the amounts of MXD6/MXD6 additive.

### Example 4—Polyether Additive Preparation

PP-g-MA is used as received in a premix with PP and PTMEG to provide the source material for the extrusion step. Uvinul® 4050 FF, Ethanox® 330, Chimassorb® 944 FDL, Hostanox® P-EPQ P, Cyanox® 1790, Solvaperm Yellow 2G, zinc stearate, beta-cyclodextrin, 5-Sulfoisophtalic acid dimethyl ester sodium salt (SIM ester), and Octenyl succinic anhydride (n-OSA) are added to PTMEG before premixing with PP and PP-g-MA, respectively. The premix is directly fed into the extruder.

The melt extruder used is a co-rotating, 27 mm extruder screw diameter and screw length to diameter (L:D) ratio of 36:1, for example, Leistritz Micro 27 36D model melt extruder. The polymer processing rate is about 5 kg/hr. Stage-wise operating temperatures are: water at room temperature (TO), 200° c. (T1-T4), 205° c. (T5-T7), 210° c. (T8) and 220° c. (T9). The desired molten material is extruded into a deionized water cooling bath. The cooled polymer strands are pelletized with a Pell-tec pelletizer into typical cylindrical granules of about 2 mm diameter and about 3 mm length.

Either of the PTMEG and/or PP-g-MA in the final polyether additive composition may be varied by adjusting the amounts of polyether and/or PP-g-MA, respectively. Either of the Uvinul® 4050 FF, Chimassorb® 944 FDL, Hostanox® P-EPQ P, Cyanox® 1790, Solvaperm Yellow 2G, zinc stearate, beta-Cyclodextrin, SIM ester, n-OSA and/or Ethanox® 330 in the final polyether additive composition may be varied by adjusting the respective amounts as well.

In one embodiment, 1000 kg of polyether additive product may be prepared using the following component quantities as listed in Table 3.

TABLE 3

| | 2a | 2b | 2c | 2d | 2e | 2f | 2g | 2h | 2i | 2j |
|---|---|---|---|---|---|---|---|---|---|---|
| | Amt, | Amt, | Amt, | Amt, | Amt, | Amt, | Amt, | Amt, | Amt, | Amt, |
| Component | kg | kg | kg | kg | kg | kg | kg | kg | kg | kg |
| Polypropylene | 900 | 300 | 299.48 | 299.3 | 288.3 | 288.3 | 900 | 900 | 900 | 870 |
| Lumicene ® | | | | | | | | | | |
| Terathane ® | 89.8 | 198.63 | 200 | 200 | 200 | 200 | 100 | 100 | 100 | 100 |
| PTMEG 1400 | | | | | | | | | | |
| PP-g-MA | 0 | 500 | 499.1 | 499.2 | 480.3 | 480.3 | 0 | 0 | 0 | 0 |
| Orevac ® | | | | | | | | | | |
| CA 100 | | | | | | | | | | |
| Uvinul ® | 1 | 1.33 | 1.33 | 1.33 | 1.33 | 1.33 | 1 | 5 | 1 | 1 |
| 4050 FF | | | | | | | | | | |
| Ethanox ® | 0.02 | 0.04 | 0.08 | 0.08 | 0.08 | 0.08 | 0.02 | 0.02 | 0.05 | 0.02 |
| 330 | | | | | | | | | | |
| Solvaperm | 0 | 0 | 0.005 | 0.005 | 0.005 | 0.005 | 0.01 | 0.01 | 0.01 | 0.01 |
| Yellow 2G | | | | | | | | | | |
| Zinc stearate | 0 | 0 | 0 | 0.09 | 0 | 0 | 0 | 0 | 0 | 0 |
| Beta- | 0 | 0 | 0 | 0 | 30 | 0 | 0 | 0 | 0 | 0 |
| Cyclodextrin | | | | | | | | | | |
| SIM ester | 0 | 0 | 0 | 0 | 0 | 30 | 0 | 0 | 0 | 0 |
| Octenyl | 0 | 0 | 0 | 0 | 0 | 0 | 0 | 0 | 0 | 3 |
| succinic | | | | | | | | | | |
| anhydride | | | | | | | | | | |
| Terathane ® | 0 | 0 | 0 | 0 | 0 | 0 | 0 | 0 | 0 | 0 |
| PTMEG 2900 | | | | | | | | | | |
| Hostanox ® | 0 | 0 | 0 | 0 | 0 | 0 | 0 | 0 | 0 | 0 |
| P-EPQ P | | | | | | | | | | |
| Chimassorb ® | 0 | 0 | 0 | 0 | 0 | 0 | 0 | 0 | 0 | 0 |
| 944 FDL | | | | | | | | | | |
| Cyanox ® | 0 | 0 | 0 | 0 | 0 | 0 | 0 | 0 | 0 | 0 |
| 1790 | | | | | | | | | | |

| | 2k | 2l | 2m | 2n | 2o | 2p | 2q |
|---|---|---|---|---|---|---|---|
| | Amt, | Amt, | Amt, | Amt, | Amt, | Amt, | Amt, |
| Component | kg | kg | kg | kg | kg | kg | kg |
| Polypropylene | 894.5 | 984.5 | 870 | 865 | 870 | 394 | 389 |
| Lumicene ® | | | | | | | |
| Terathane ® | 100 | 0 | 100 | 100 | 100 | 100 | 0 |
| PTMEG 1400 | | | | | | | |
| PP-g-MA | 0 | 0 | 0 | 0 | 0 | 500 | 500 |
| Orevac ® | | | | | | | |
| CA 100 | | | | | | | |
| Uvinul ® | 5 | 5 | 0 | 0 | 5 | 1 | 1 |
| 4050 FF | | | | | | | |
| Ethanox ® | 0.5 | 0.5 | 10 | 0.02 | 10 | 5 | 5 |
| 330 | | | | | | | |
| Solvaperm | 0.01 | 0.01 | 0.01 | 0.01 | 0.0025 | 0.0025 | 0.0025 |
| Yellow 2G | | | | | | | |
| Zinc stearate | 0 | 0 | 0 | 0 | 0 | 0 | 0 |
| Beta- | 0 | 0 | 0 | 0 | 0 | 0 | 0 |
| Cyclodextrin | | | | | | | |
| SIM ester | 0 | 0 | 0 | 0 | 0 | 0 | 0 |
| Octenyl | 0 | 0 | 0 | 0 | 0 | 0 | 0 |
| succinic | | | | | | | |
| anhydride | | | | | | | |
| Terathane ® | 0 | 100 | 0 | 0 | 0 | 0 | 100 |
| PTMEG 2900 | | | | | | | |
| Hostanox ® | 0 | 0 | 5 | 5 | 0 | 0 | 0 |
| P-EPQ P | | | | | | | |
| Chimassorb ® | 0 | 0 | 15 | 20 | 15 | 0 | 0 |
| 944 FDL | | | | | | | |
| Cyanox ® | 0 | 0 | 0 | 10 | 0 | 0 | 5 |
| 1790 | | | | | | | |

### Example 5—“all in One” Masterbatch Preparation

PP or PP-g-MA are used as received in a premix with Cobalt stearate and PTMEG to provide the source material for the extrusion step. Uvinul® 4050 FF. Ethanox® 330, Solvaperm Yellow 2G, are added to PTMEG before premixing with PP or PP-g-MA and Cobalt stearate, respectively. The premix is directly fed into the extruder.

The melt extruder used is a co-rotating, 27 mm extruder screw diameter and screw length to diameter (L:D) ratio of 36:1, for example, Leistritz Micro 27 36D model melt extruder. The polymer processing rate is about 5 kg/ln. Stage-wise operating temperatures are: water at room temperature (TO), 200° c. (T1-T4), 205° c. (T5-T7), 210° c. (T8) and 220° c. (T9). The desired molten material is extruded into a deionized watercooling bath. The cooled polymer strands are pelletized with a Pell-tec pelletizer into typical cylindrical granules of about 2 mm diameter and about 3 mm length.

Either of the PTMEG and/or Cobalt stearate in the final “all in one” additive composition may be varied by adjusting the amounts of polyether and/or Cobalt stearate, respectively. Either of the Uvinul® 4050 FF, Solvaperm Yellow 2G, and/or Ethanox® 330 in the final additive composition may be varied by adjusting the respective amounts as well.

In one embodiment, 1000 kg of “all in one” additive product may be prepared using the following component quantities as listed in Table 4.

TABLE 4

| | 3a | 3b | 3c | 3d |
|---|---|---|---|---|
| Component | Amt, kg | Amt, kg | Amt, kg | Amt, kg |
| Polypropylene | 864.5 | 351 | 364 | 0 |
| PP-g-MA Orevac ® CA | 0 | 500 | 500 | 860 |
| Terathane ® PTMEG | 100 | 100 | 100 | 100 |
| Cobalt Stearate | 30 | 30 | 30 | 30 |
| Uvinul ® 4050 FF | 5 | 1 | 1 | 1 |
| Ethanox ® 330 | 0.5 | 5 | 5 | 5 |
| Solvaperm Yellow 2G | 0.01 | 0.0025 | 0.0025 | 0.0025 |

### Example 6—Incorporation of Catalyst Masterbatch and Polyether Additive into Polyolefins

Catalyst masterbatch and polyether additive may be mixed prior to use for injection molding with any polyolefin base resin.

In this example, catalyst masterbatch as shown in Examples 1a-1m is used in concentrations of 1-15 wt % for injection molding into preforms and further stretch-blow molding into bottles. Polyether additive (cf. Example 2a-f) may be used in a premix with the base resin or may be premixed with catalyst masterbatch to obtain approximately 0.5-6 wt % Terathane® PTMEG in the final application. PTMEG amount may be varied by using different amounts of polyether additive.

### Example 7—Incorporation of “all in One” Masterbatch into Polyolefins

“All in one” masterbatch may be mixed prior to use for injection molding with any polyolefin base resin.

In this example, “all in one” masterbatch as shown in Example 3a-3d is used in concentrations of 1-15 wt % for injection molding into preforms and further stretch-blow molding into bottles to obtain approximately 0.4-2 wt % Terathane® PTMEG 1400 in the final application. PTMEG amount may be varied by using different amounts of “all in one” masterbatch.

### Example 8—Effect of Preform Storage Time

Bottles stretch blow molded of preforms made from compositions disclosed herein are expected to show enhanced oxygen barrier properties when preforms are stored for several days.

While the illustrative embodiments of the invention have been described with particularity, it will be understood that various other modifications will be apparent to and may be readily made by those skilled in the art without departing from the spirit and scope of the invention. Accordingly, it is not intended that the scope of the claims hereof be limited to the examples and descriptions set forth herein but rather that the claims be construed as encompassing all the features of patentable novelty which reside in the present invention, including all features which would be treated as equivalents thereof by those skilled in the art to which the invention pertains.

All patents, patent applications, test procedures, priority documents, articles, publications, manuals, and other documents cited herein are fully incorporated by reference to

the extent such disclosure is not inconsistent with this invention and for all jurisdictions in which such incorporation is permitted.

When numerical lower limits and numerical upper limits are listed herein, ranges from any lower limit to any upper limit are contemplated.

1. A composition comprising:
a) polyolefin,
b) polymer containing an oxidizable component, said polymer selected from the group consisting of polyethers, copolyether esters, copolyether amides, at least partially aromatic polyamides, and combinations thereof,
c) a transition metal compound or a mixture of transition metal compounds, and
d) one or more additives selected from the group consisting of stabilizers, antioxidants, solubilizers, agents which counteract fragrances or odors, complexing agents, compatibilizing agents, colorants and promoters enhancing oxygen barrier properties,
said composition characterized in that when an article is formed therefrom, the article exhibits improved gas barrier, optical appearance and/or mechanical properties as compared to a control.

2. The composition of claim 1 wherein the polymer b) comprises a polyether glycol.

3. The composition of claim 1 wherein the polymer b) comprises a modified polyether

4. The composition of claim 1, wherein the transition metal compound comprises a mixture of cobalt stearate and zinc stearate or zinc acetate.

5. The composition of claim 1, wherein the one or more additives is beta-cyclodextrin.

6. The composition of claim 1, wherein the one or more additives is sodium stearate, magnesium stearate, a mixture thereof or alkenyl succinic anhydride.

7. The composition of claim 1, wherein the one or more additives is a colorant.

8. The composition of claim 7 wherein the colorant is solvaperm yellow.

9. The composition of claim 1, wherein the one or more additives is SIM ester.

10. The composition of claim 1, wherein the one or more additives is a stabilizer comprising a monomeric, oligomeric or polymeric hindered amine light stabilizer (HALS).

11. The composition of claim 1, wherein the one or more additives are beta-cyclodextrin, sodium stearate and/or magnesium stearate, solvaperm yellow and SIM ester.

12. The composition of claim 1, wherein the one or more additives includes maleic anhydride grafted polyolefin.

13. A composition comprising:
a) from 90 to 99 parts polyolefin,
b) from 0.1 to 10 parts of polymer containing an oxidizable component, said polymer selected from the group consisting of polyethers, copolyether esters, copolyether amides, at least partially aromatic polyamides, and combinations thereof,
c) from 10 to 1000 parts per million (ppm) or mg/kg of transition metal added via a transition metal compound or mixture of transition metal compounds, and
d) from ≥0 to 5 parts of the one or more additives, where the sum of all parts is 100.

14. The composition of claim 13 wherein the polymer b) comprises a polyether glycol.

15. The composition of claim 13 wherein the polymer b) comprises a modified polyether glycol.

16. The composition of claim 13, comprising 10 to 400 ppm or mg/kg of transition metal added via a transition metal compound or mixture of transition metal compounds.

17. The composition of claim 13 wherein the polymer b) containing an oxidizable component comprises MXD6 polyamide.

18. A process for forming an article comprising:
providing a comprosition comprising:
a) polyolefin,
b) polymer containing an oxidizable component, said polymer selected from the group consisting of polyethers, copolyether esters, copolyether amides, at least partially aromatic polyamides, and combinations thereof,
c) a transition metal compound or a mixture of transition metal compounds, and
d) one or more additives selected from the group consisting of stabilizers, antioxidants, solubilizers, agents which counteract fragrances or odors, complexing agents, compatibilizing agents, colorants and promoters enhancing oxygen barrier properties,
said composition characterized in that when an article is formed therefrom, the article exhibits improved gas barrier, optical appearance and/or mechanical properties as compared to a control;
forming the composition into an article.

19. The process according to claim 18, wherein the article is oriented in the x and/or y direction from 50 to 400%.

20. The process according to claim 18, wherein the article is oriented in a machine direction (MD) of 1:5 to 1:10 equal to 500% to 1000% or a transverse direction (TD) of 1:5 to 1:10 equal to 500, to 1000%.

21. (canceled)
